(19) United States
(12) Patent Application Publication
(10) Pub. No.: US 2006/0284731 A1
(43) Pub. Date: Dec. 21, 2006

(54) Passenger detection system

(75) Inventors: Shinji Ando, Nukata-gun (JP); Tsutomu Kamizono, Nagoya-city (JP)

Correspondence Address: HARNESS, DICKEY & PIERCE, P.L.C., P.O. BOX 828, BLOOMFIELD HILLS, MI, 48303, US

(73) Assignees: DENSO Corporation, Kariya-city (JP); Nippon Soken, Inc., Nishio-city (JP)

(21) Appl. No.: 11/453,313

(22) Filed: Jun. 14, 2006

(30) Foreign Application Priority Data
Jun. 15, 2005 (JP) 2005-175200

(51) Int. Cl. G08B 13/26

(52) U.S. Cl. 340/561

(57) ABSTRACT

A passenger detection system has an antenna electrode and a guard electrode mounted to a seat bottom of a seat of a vehicle. The passenger detection system further has a power source means for detecting a presence of a passenger on the seat. The power source means applies electric power to the antenna electrode so that a load current flows in the antenna electrode and a weak electric field is generated from the antenna electrode by the load current. The power source means detects an electric current generated in the antenna electrode in response to the electric field. A capacitance between the antenna electrode and a floor of the vehicle is determined based on the detected electric current in a condition that an electric field generated from the antenna electrode on a side of the guard electrode is cancelled by the guard electrode, to thereby detect a passenger on the seat.

### CROSS REFERENCE TO RELATED APPLICATION

This application is based on Japanese Patent Application No. 2005-175200 filed on Jun. 15, 2005, the disclosure of which is incorporated herein by reference.

### FIELD OF THE INVENTION

The present invention relates to a passenger detection system for detecting a passenger sitting on a seat for a vehicle.

### BACKGROUND OF THE INVENTION

In vehicles, an air bag system is generally provided for reducing shock that a passenger experiences during a collision. Air bags are generally mounted in front of a driver's seat as well as a front passenger's seat. For example, an occurrence of a collision is determined in a calculation means based on an output signals from a sensor such as an acceleration sensor installed in a vehicle. When the collision is determined, air bags are triggered.

In a typical air bag system, air bags are triggered based on the occurrence of a collision regardless of the presence or absence of a passenger. However, it has been recently required to limit the expansion of the air bag depending on a passenger or a circumstance on the front passenger seat. In a case that the passenger on the front passenger seat is adult, the shock applied to the passenger is effectively reduced by the air bag.

For example, Japanese Patent Publication No. 2003-530576 (U.S. Pat. No. 6,329,913, U.S. Pat. No. 6,329,914) and No. 2002-36929 discloses a passenger detection system for detecting the presence of a passenger on the seat. In the system, electrodes are installed in the seat. The presence of the passenger is detected based on the change of electric current flowing in the electrodes when a passenger sits on the seat.

For example, the presence of the passenger is detected by determining a capacitance between the vehicle and the electrode. While sitting on the seat, the passenger exists between the electrode and the vehicle. As such, the capacitance between the electrode and the vehicle changes due to the passenger existing between them. Namely, the above system detects the passenger based on the change of the capacitance.

In such a passenger detection system, the change of electric current in the electrode is affected by a condition of the passenger and a distance between the passenger and the electrode. For example, if the passenger is sitting on the seat with a cushion or in heavy clothes, the electric current in the electrode varies. The above system can detect the presence of the passenger. However, there are large detection errors depending on the condition of the passenger, and it is difficult to determine a physique or attribute of the passenger.

For example, if a child restraint or infant seat is mounted on the front passenger seat in a rear-facing manner, the head of a child is positioned close to an expansion opening of the air bag. In this case, it is difficult to protect the child from the shock. Further, the head is likely to be affected by an expansion pressure of the air bag.

### SUMMARY OF THE INVENTION

The present invention is made in view of the foregoing matter, and it is an object of the present invention to provide a passenger detection system capable of for detecting a passenger on a seat of a vehicle with improved accuracy.

According to an aspect of the present invention, a passenger detection system has an antenna electrode, a guard electrode and a power source means. The antenna electrode is mounted to a seat bottom of the seat and the guard electrode is mounted between a surface of the seat bottom and the antenna electrode. The power source means is connected to the antenna electrode and the vehicle. The power source means applies electric power so that a load current flows in the antenna electrode and a weak electric field is generated from the antenna electrode by the load current. The power source means detects an electric current flowing in the antenna electrode in response to the weak electric field. A capacitance between the antenna electrode and a floor of the vehicle is determined based on the electric current flowing in the antenna electrode in a condition that a weak electric field generated from the antenna electrode on a side of the guard electrode is cancelled by the guard electrode.

Accordingly, the passenger on the seat is detected based on the capacitance determined in a condition that the weak electric field generated from the antenna electrode on the side of the guard electrode is cancelled. Namely, the passenger on the seat is not directly detected. In other words, the passenger is detected based on a displacement of the antenna electrode due to a weight of the passenger. The capacitance of the passenger is not detected. Therefore, it is less likely that the detection result will be affected by conditions of the passenger such as clothes of the passenger. As such, detection errors caused by the conditions of the passenger reduces.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic side view of a vehicle seat having a passenger detection system according to an example embodiment of the present invention;

FIG. 2 is a schematic transparent view of a seat bottom of the seat for showing an antenna electrode of the passenger detection system according to the example embodiment of the present invention;

FIG. 3 is a cross-sectional view of the antenna electrode taken along line III-III of FIG. 2;

FIG. 4 is a schematic diagram of the passenger detection system according to the example embodiment of the present invention;

FIG. 5 is a schematic diagram of a passenger detection system as a comparison example;

FIG. 6 is a graph showing a relationship between a weight of a passenger and a capacitance; and

FIG. 7 is a schematic diagram of a passenger detection system as a modification of the example embodiment shown in FIG. 4.

### DETAILED DESCRIPTION OF EXAMPLE EMBODIMENT

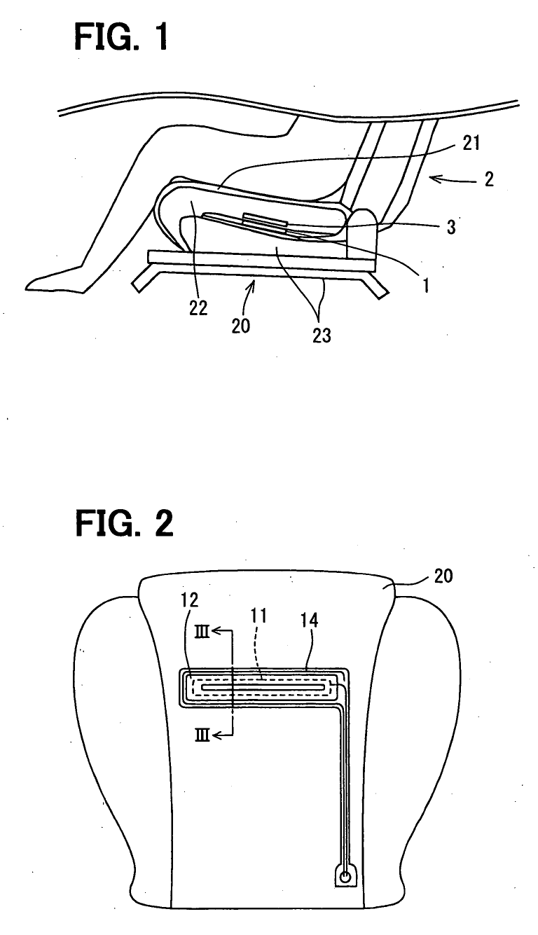

An example embodiment of the passenger detection system for detecting a passenger sitting on a seat will now be described with reference to FIGS. 1 to 4. The passenger detection system has an antenna electrode 1, a guard electrode 3, and a power source unit 4. The antenna electrode 1 and the guard electrode 3 are mounted to a seat 2 of a vehicle.

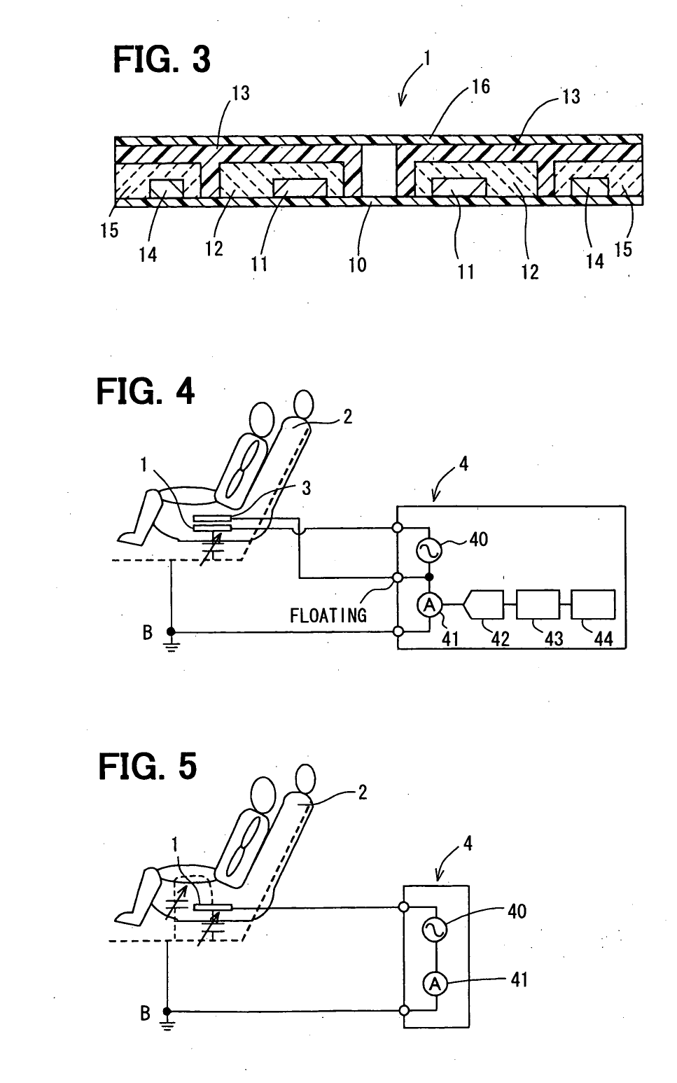

The antenna electrode 1 shown in FIGS. 2 and 3 is formed as follows. First, a resin sheet 10 having electrical insulation is prepared. Next, silver ink is applied on the resin sheet 10 and dried thereon, thereby forming a first conductive part 11. The first conductive part 11 has a substantially rectangular loop shape, as shown in FIG. 2.

Then, carbon ink is applied on the first conductive part 11 and is dried, thereby forming a first electrode part 12. The first electrode part 12 covers the first conductive part 11. The first electrode part 12 has a shape similar to that of the first conductive part 11. For example, the first electrode part 12 has a substantially rectangular loop shape with a slit at a middle portion thereof. The slit of the first electrode part 12 is coincide with the center of the first conductive part 11.

Next, silver ink is applied on the outer periphery of the first conductive part 11 and is dried, thereby forming a second conductive part 14. Then, carbon ink is applied on the second conductive part 14 and is dried, thereby forming a second electrode part 15. The second electrode part 15 covers the second conductive part 14. The second electrode part 15 is formed at a position adjacent to the first electrode part 12, but does not contact the first electrode part 12.

Further, an adhesive 13 having electrical insulation is applied on the first electrode part 12 and the second electrode part 15, and then a resin sheet 16 having electrical insulation is layered thereon. Accordingly, the antenna electrode 1 is produced.

The antenna electrode 1 is arranged on a seat bottom 20 of the seat 2, as shown in FIGS. 1 and 2. The seat 2 is for example constructed of a cover member 21, a cushion pad 22, a seat cushion spring (not shown) and an a seat frame 23. In the cover member 21, a cover providing an outer surface of the seat 2 and a ramie layer or fabric layer are integrally formed. The seat cushion spring is arranged on the seat frame 23. The cushion pad 22 is arranged on the seat cushion spring. Further, the cushion pad 22 is covered with the cover member 21.

The antenna electrode 1, which has a substantial foil or thin plate shape, is arranged on the seat bottom 20 such that a longitudinal direction of the rectangular first electrode part 12 coincides with a transverse direction of the vehicle. For example, the antenna electrode 1 is disposed between the cushion pad 22 and the seat cushion spring. Also, the antenna electrode 1 is arranged substantially parallel to the surface of the seat 2.

The guard electrode 3 is produced in a manner similar to that of the antenna electrode 1. The guard electrode 3 is disposed above the antenna electrode 1, between the cushion pad 22 and the seat cushion spring. A resin member having electrical insulation is interposed between the guard electrode 3 and the antenna electrode 1. The resin member is for example made of the same material as the cushion pad 22.

The first conductive part 11 and the second conductive part 14 of the antenna electrode 1 are electrically connected to the power source unit 4. Likewise, the guard electrode 3 is electrically connected to the power source unit 4. In FIG. 1, the power source unit 4 is not illustrated, for convenience of illustration purpose.

The power source unit 4 applies electric power having a predetermined characteristic to the antenna electrode 1 and the guard electrode 3. The power source unit 4 also detects electric current (potential current) caused by electric fields generated from the antenna electrode 1 and the guard electrode 3. The power source unit 4 calculates an electric field at a position where the guard electrode 3 is located based on an electric current that flows in the guard electrode 3 when the guard electrode 3 receives the electric field from the antenna electrode 1. Further, the power source unit 4 applies electric power to the guard electrode 3 for canceling the electric field generated from the antenna electrode 1.

For example, the power source unit 4 has a power source part 40 for applying electric power to the antenna electrode 1 and the guard electrode 3 so that a load current flows in the antenna electrode 1 and the guard electrode 3. The power source unit 4 also has a current detecting part 41 for detecting an electric current flowing in the antenna electrode 1 and the guard electrode 3.

Further, the power source unit 4 has a calculating means for calculating a capacitance between the antenna electrode 1 and the vehicle (e.g., a floor) based on signals of the currents generated in and detected from the antenna electrode 1. That is, the calculating means calculates the capacitance based on the load current flowing in the antenna electrode 1 and the current flowing in the antenna electrode 1 in response to the electric field. The calculating means for example includes an A/D converter 42, a digital signal processor (e.g., Discrete Fourier Transform) 43, and a micro processing unit 44.

Furthermore, the power source unit 4 is connected to a body B of the vehicle so that the body B has a predetermined potential. The body B and the seat 2 are electrically insulated.

Next, an operation of the passenger detection system will be described. Referring to FIG. 4, when the electric power is applied to the antenna electrode 1 in a condition that the body B is grounded the load current flows in the antenna electrode 1. By the load current flowing in the antenna electrode 1, weak electric fields are produced from an upper surface and a lower surface of the antenna electrode 1. The electric fields expand in the upward and downward directions.

The guard electrode 3 exists in the electric field produced from the antenna electrode 1 in the upward direction. Thus, an electric current (potential current) occurs in the guard electrode 3 by the electric field generated from the antenna electrode 1. The power source unit 4 detects the electric current flowing in the guard electrode 3, and calculates the electric field around the guard electrode 3 based on the detected electric current.

Then, the power source unit 4 applies electric power to the guard electrode 3 so that the load current for canceling the electric field from the antenna electrode 1 flows in the guard electrode 3. By the load current, the guard electrode 3 generates the electric field. Accordingly, the electric field generated from the antenna electrode 1 on a side of the guard electrode 3 is canceled by the electric field from the guard electrode 3. As a result, electric current caused by the electric field that is generated above the antenna electrode 1 does not flow in the antenna electrode 1.

On the contrary, the electric field produced below the antenna electrode 1 generates electric current in the antenna electrode 1 according to a potential difference between the floor of the vehicle and the antenna electrode 1. Namely, when the load current occurs in the antenna electrode 1 by the electric power from the power source unit 4, the electric current flows in the antenna electrode 1 due to the electric field expanding below the antenna electrode 1. The calculating means of the power source unit 4 detects the electric current in the antenna electrode 1 and calculates the capacitance between the antenna electrode 1 and the floor of the vehicle.

The capacitance calculated in the power source unit 4 is sent to an ECU (not shown). The ECU determines a physique of a passenger sitting on the seat 2, e.g., whether the passenger is an adult-sized person or a child-sized person. When it is determined that the passenger is the adult-sized person, the ECU allows an air bag to open at a time of accident such as a collision. On the contrary, when it is determined that the passenger is the child-sized person, the ECU prohibits the air bag to open at a time of accident.

Advantageous effect of the passenger detection system of the example embodiment is compared to a passenger detection system that does not have the guard electrode 3. The passenger detection system without having the guard electrode 3 is shown in FIG. 5, as a comparison example.

The passenger detection system of the comparison example has a structure similar to that of the example embodiment shown in FIG. 4, other than the guard electrode 3.

In the passenger detection system of the comparison example, the detection of the passenger sitting on the seat 2 is made based on an electric field generated above the antenna electrode 1, similar to a conventional manner. When electric power is applied to the antenna electrode 1 to cause a load current for the determination, the electric current flows in the antenna electrode 1 due to a potential difference between the vehicle and the antenna electrode 1.

In the system of the comparison example, a capacitance is determined based on both the electric field generated above the antenna electrode 1 and the electric field generated below the antenna electrode 1. The electric field generated below the antenna electrode 1 causes electric current in the antenna electrode 1, similar to the example embodiment.

However, the electric field generated above the antenna electrode 1 also causes the electric current in the antenna electrode 1. For example, the passenger sitting on the seat 2 allows electrical connection between the antenna electrode 1 and the body B. As such, electric current occurs in the antenna electrode 1 in response to an electric field passing through the passenger. Accordingly, in the antenna electrode 1, the electric current caused by the electric field above the antenna electrode 1 and the electric current caused by the electric field below the antenna electrode 1 flow.

The electric field generated from the antenna electrode 1 largely varies while passing through the passenger on the seat 2. As such, the electric current in the antenna electrode 1 is affected by the passenger on the seat 2. Namely, the system of the comparison example determines a capacitance of the passenger based on the electric field passing through the passenger, and detects the passenger based on the detected capacitance.

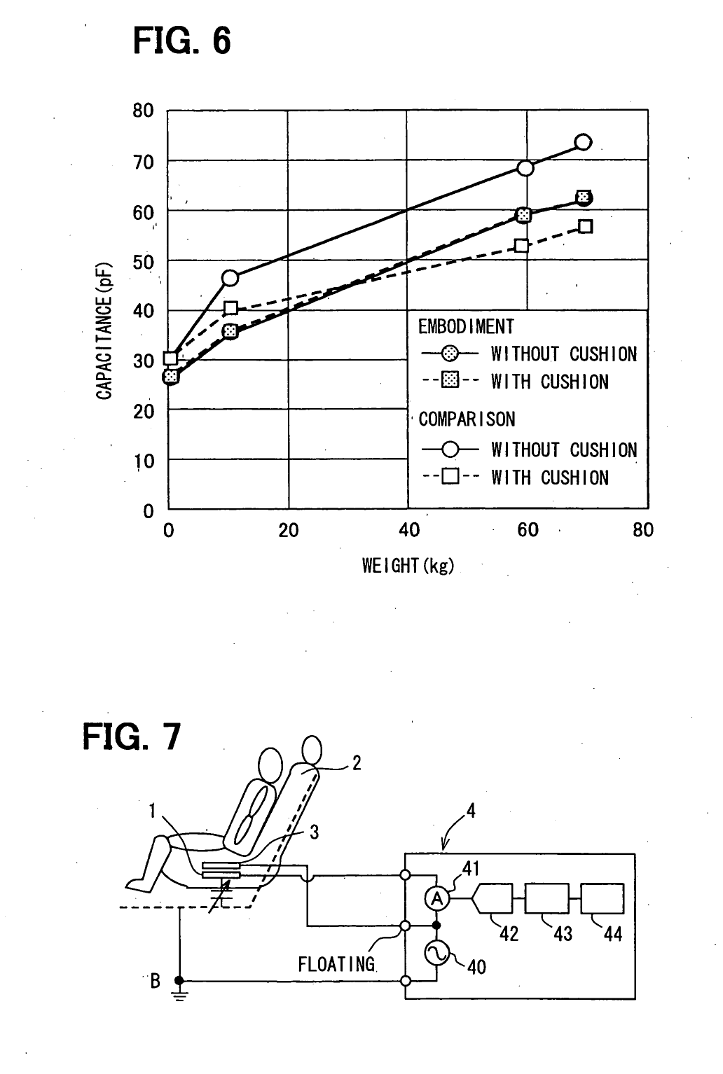

FIG. 6 shows a relationship between a weight of a passenger sitting on the seat 2 and the capacitance detected in the antenna electrode 1. The capacitance is determined in a case that the passenger uses a cushion on the seat bottom 20 and in a case that the passenger does not use the cushion.

In the system of the example embodiment, the determined capacitance is the same regardless of the presence or absence of the cushion. Namely, in the example embodiment, the result of the case using the cushion coincides with the result of the case without using the cushion, as shown in FIG. 6.

On the contrary, in the system of the comparison example, the capacitance varies depending on the presence or absence of the cushion. Namely, the capacitance is affected by conditions of the passenger, such as a weight of clothes.

In the system of the example embodiment, it is less likely that the capacitance will be affected by the conditions of the passenger. Accordingly, the passenger detection system of the example embodiment reduces detection errors.

The passenger detection system of the example embodiment will be modified as shown in FIG. 7. The passenger detection system shown in FIG. 7 has a power source unit 4 different from that of the example embodiment shown in FIG. 4. Structures other than the power source unit 4 is similar to that of the example embodiment shown in FIG. 4.

In the modified embodiment shown in FIG. 7, the electric current detecting part 41 for detecting the electric current in the electrodes 1, 3 is arranged between the electrodes 1, 3 and the power source part 40 that applies the load current to the electrodes 1, 3. Also in the modified embodiment, the passenger on the seat 2 is detected in a manner similar to that of the example embodiment shown in FIG. 4.

Accordingly, in the passenger detection system of the example embodiment, the capacitance between the antenna electrode 1 and the vehicle is measured in a condition that the electric field on the seat surface side of the antenna electrode 1 is cancelled by providing the guard electrode 3. Namely, in the antenna electrode 1, only the electric current, which is caused by the electric field generated on the side opposite to the guard electrode 3, flows. The electric current generated in the antenna electrode 1 varies based on a distance between the floor of the vehicle and the antenna electrode 1. Thus, the capacitance between the floor and the antenna electrode 1 is measured based on the load current and the electric current generated in response to the electric field below the antenna electrode 1. The passenger on the seat 2 is detected based on the detected capacitance.

The capacitance varies according to the distance between the floor and the antenna electrode 1. Since the antenna electrode 1 is mounted to the seat bottom 20, when the passenger sits on the seat 2, the seat bottom 20 is compressed and falls down due to the weight of the passenger. With this, the distance between the antenna electrode 1 and the floor reduces. As such, the capacitance changes. Accordingly, the amount of compression of the seat bottom 20 is detected based on the change of the capacitance, to thereby determine the presence of the passenger on the seat 2. Namely, the presence of the passenger is not detected based on the capacitance of the passenger. Therefore, it is less likely that the detection result will be affected by conditions such as clothes of the passenger.

The structure of the guard electrode 3 is not particularly limited. For example, the guard electrode 3 has a structure similar to that of the antenna electrode 1.

The antenna electrode 1 is preferably arranged at a position where the distance between itself and the floor changes when the passenger sits on the seat 2. Accordingly, the presence of the passenger on the seat 2 is detected based on the change of the distance.

More preferably, the antenna electrode 1 is arranged at a position where the amount of compression of the seat 2 is large when the passenger sits thereon. When the amount of the compression of the seat 2 is larger, the current passing through the antenna electrode 1 more changes before and after the compression. Accordingly, the presence of the passenger is easily detected, and detection accuracy improves.

The arrangement position of the antenna electrode 1 is not particularly limited as long as the distance between the antenna electrode 1 and the vehicle floor changes when the passenger sits on the seat. In the above example embodiment, the antenna electrode 1 is exemplary arranged between the cushion pad 22 and the seat cushion spring. Alternatively, the antenna electrode 1 is arranged between the cushion pad 22 and the cover member 21.

In a case that the antenna electrode 1 is arranged under the seat cushion spring, the weight of the passenger is absorbed by the seat spring. Thus, the degree of change of the distance is reduced. Therefore, the antenna electrode 1 is preferably arranged above the seat spring.

In the above example embodiment, the antenna electrode 1 and the guard electrode 3 are arranged under the cushion pad 22. Therefore, it is less likely that the passenger will feel the antenna electrode 1 and the guard electrode 3 when sits on the seat 2. As such, the above arrangement of the antenna electrode and the guard electrode 3 will not reduce seating comfort.

The guard electrode 3 is not particularly limited as long as the electric field generated above the antenna electrode 1 can be canceled. The guard electrode 3 can be provided to absorb the electric field generated from the antenna electrode 1. Alternatively, the guard electrode 3 can be provided to generate an electric field having a phase different from the electric field generated from the antenna electrode 1 so that the electric field from the antenna electrode 1 is cancelled. In the above example embodiment, the guard electrode 3 is provided to generate an electric field so that the electric field generated from the antenna electrode 1 on the side of the guard electrode 3 is cancelled. In this case, the guard electrode 3 is connected to the power source unit 4.

The passenger detection system can include a determination means for determining the physique of the passenger based on the capacitance. For example, it is determined whether the weight of the passenger is larger than a predetermined value, i.e., whether the passenger is the adult-sized person or child-sized person. The determination result is sent to a passenger protection system including a passenger protection device such as air bag. The passenger protection system controls the operation of the protection device based on the determination result. If it is determined that the passenger is the child-sized person, the air bag may interfere with the head of the passenger. In this case, the passenger protection system instructs not to expand the air bag.

For example, the determination means can be integrally provided in the power source unit 4. Alternatively, the determination means can be provided separate from the power source unit 4. In such a case, the determination means can be provided by a calculation means such as ECU previously provided in the vehicle.

Furthermore, when the passenger sits on the seat bottom 20, the position of the antenna electrode 1 is lowered due to the weight of the passenger. The displacement of the antenna electrode 1 and the weight of the passenger have a linear relationship. Further, the capacitance between the antenna electrode 1 and the floor is proportional to the distance between the antenna electrode 1 and the floor. Namely, the capacitance and the weight of the passenger are mutually related.

As a result, the weight of the passenger is determined based on the capacitance. A threshold is predetermined so that the passenger having a weight equal to or larger than the predetermined value is the adult-sized person. The physique of the passenger is determined by comparing the capacitance to the threshold value.

A method of determining the physique of the passenger is not particularly limited to the above. Alternatively, the weight of the passenger is calculated based on the capacitance and the calculated weight is compared to a predetermined threshold value.

For example, the seat bottom 20 is compressed due to the weight of the passenger. At this time, the antenna electrode 1 displaces toward the floor to reduce the distance between them. In this condition, the electric current flowing in the antenna electrode 1 is detected. The electric current flowing in the antenna electrode 1 changes with the distance between the antenna electrode 1 and the floor. Therefore, the distance and the amount of displacement of the antenna electrode 1 can be determined based on the electric current flowing in the antenna electrode 1. Further, based on the amount of displacement of the antenna electrode 1, the weight of the passenger can be determined according to an elasticity of the seat bottom 20.

When the physique of the passenger is determined by the determination means, information from external sensors can be used in addition to the results from the passenger detection system. For example, a camera is provided in a compartment of the vehicle. The images from the camera can be used for determination of the physique of the passenger. By using the information (output signals) from external sensors, detection accuracy further improves.

Further, the determination can be made by using plural antenna electrodes 1 and guard electrodes 3 to improve accuracy. Further, the arrangement position of the antenna electrode 1 and the guard electrode 3 is not particularly limited to the illustration of FIG. 2. Additional antenna electrode 1 and guard electrode 3 can be provided e.g., on a seat back of the seat 2 to more accurately detect or determine an object on the seat 2. In this case, the determination can be made based on a capacitance between the antenna electrode in the seat back and a member connected to the floor behind the seat back.

The example embodiments of the present invention are described above. However, the present invention is not limited to the above example embodiments, but may be implemented in other ways without departing from the spirit of the invention.

What is claimed is:

1. A passenger detection system for detecting a passenger sitting on a seat of a vehicle, comprising:
an antenna electrode mounted to a seat bottom of the seat;
a guard electrode disposed between the antenna electrode and a surface of the seat bottom; and
a power source means connected to the antenna electrode and the vehicle, the power source means provided to apply electric power to the antenna electrode so that a load current flows in the antenna electrode and a weak electric field is produced from the antenna electrode and to detect an electric current flowing in the antenna electrode in response to the electric field, wherein a capacitance between the antenna electrode and a floor of the vehicle is determined based on the detected electric current in a condition that an electric field produced from the antenna electrode on a side of the guard electrode is cancelled by the guard electrode, thereby to detect a passenger on the seat.

2. The passenger detection system according to claim 1, wherein the antenna electrode is located at a part of the seat bottom such that a distance between the antenna electrode and the floor reduces when a passenger sits on the seat bottom.

3. The passenger detection system according to claim 1, wherein
the seat has a cushion pad and a cover member that is disposed on the cushion pad and defines the surface, and
the antenna electrode is disposed on an opposite side as the cover member with respect to the cushion pad.

4. The passenger detection system according to claim 1, wherein the guard electrode is provided to generate an electric field that cancels the electric field generated from the antenna electrode on a side of the guard electrode.

5. The passenger detection system according to claim 4, wherein the guard electrode is connected to the power source means.

6. A passenger detection system for a seat of a vehicle, comprising:
an antenna electrode mounted to a seat bottom of the seat;
a guard electrode mounted between a surface of the seat bottom and the antenna electrode;
a power source unit connected to the antenna electrode and the vehicle, the power source unit including a first part that applies electric power to the antenna electrode so that a load current occurs in the antenna electrode and a weak electric field is produced from the antenna electrode, a second part that detects an electric current flowing in the antenna electrode in response to the weak electric field; and
a calculation part that calculates a capacitance between the antenna electrode and a floor of the vehicle based on the electric current detected by the second part for detecting a passenger on the seat, wherein
the guard electrode is provided such that a weak electric field generated from the antenna electrode on a side of the guard electrode is cancelled.

7. The passenger detection system according to claim 6, wherein the calculation part is included in the power source unit.

8. The passenger detection system according to claim 6, wherein
the seat has a cushion member and a cover member that covers the cushion member and defines the surface, and
the antenna electrode is disposed under the cushion member and the guard electrode is disposed between the antenna electrode and the cushion member.

9. The passenger detection system according to claim 6, wherein
the first part of the power source unit is connected to the guard electrode to apply electric power to the guard electrode such that an electric field is produced from the guard electrode for canceling the electric field from the antenna electrode on the side of the guard electrode.
